(19) United States
(12) Patent Application Publication
(10) Pub. No.: US 2014/0348463 A1
(43) Pub. Date: Nov. 27, 2014

(54) OPTICAL DEVICE AND METHOD FOR MANUFACUTURING THE OPTICAL DEVICE

(71) Applicants: Masafumi IDE, Tokyo (JP); Kaoru YODA, Kitasaku-gun (JP); Shinpei FUKAYA, Tokyo (JP)

(72) Inventors: Masafumi IDE, Tokyo (JP); Kaoru YODA, Kitasaku-gun (JP); Shinpei FUKAYA, Tokyo (JP)

(73) Assignee: CITIZEN HOLDINGS CO., LTD., Tokyo (JP)

(21) Appl. No.: 14/458,140

(22) Filed: Aug. 12, 2014

Related U.S. Application Data
(62) Division of application No. 13/644,637, filed on Oct. 4, 2012.

(30) Foreign Application Priority Data
Oct. 4, 2011 (JP) 2011-219998

(51) Int. Cl. G02B 6/42; G02B 6/36

(52) U.S. Cl. CPC G02B 6/4243; G02B 6/3684; G02B 6/423; G02B 6/3692; G02B 6/4239; G02B 2006/12176
USPC 385/14; 156/278; 216/24

(57) ABSTRACT

The invention provides an optical device and an optical device manufacturing method wherein provisions are made to be able to precisely align an optical fiber relative to a substrate without heating the substrate and to maintain the optimum alignment condition for an extended period of time. More specifically, the invention provides an optical device manufacturing method which includes the steps of forming a first metallic film on a portion of a substrate, forming a second metallic film on a portion of the outer circumference of an optical fiber, and bonding together the first metallic film and the second metallic film by surface activated bonding, and an optical device manufactured by such a manufacturing method.

### RELATED APPLICATIONS

This application is a divisional application of U.S. application Ser. No. 13644,637, which is a U.S. patent application that claims benefit of JP 2011-219998, filed on Oct. 4, 2011, all of which is hereby incorporated by reference.

### TECHNICAL FIELD

The present invention relates to an optical device manufactured by fixedly bonding an optical fiber to a substrate, and a method for manufacturing such an optical device.

### BACKGROUND

In an optical device formed by mounting an optical fiber as an optical waveguide, a semiconductor laser, a wavelength conversion element, etc., on a substrate, the optical fiber and other optical elements mounted on the substrate must be aligned so as to achieve optimum optical coupling between the respective elements and then fixedly bonded to the substrate by maintaining the optimum condition.

An optical module manufacturing method is known that forms a V-shaped groove in the surface of a silicon substrate, coats the surface of the V-shaped groove as well as the surface of an optical fiber with an Au film, and presses the optical fiber onto the bottom face of the V-shaped groove to fixedly bond them together (for example, refer to Patent Document 1). In the manufacturing method of Patent Document 1, the optical fiber is fixedly bonded to the V-shaped groove by a bonding tool while heating the silicon substrate.

According to the optical module manufacturing method of Patent Document 1, the interface energy at the contact interface between the Au film on the surface of the V-shaped groove and the Au film on the surface of the optical fiber rises due to the applied heat and pressure, and interdiffusion of metal atoms between the Au film surfaces, thus bonding the Au films together. Accordingly, as Patent Document 1 describes, the optical fiber can be fixed precisely because the optical fiber is bonded to the substrate without interposing an adhesive, solder, or like layer therebetween.

Patent Document 1: JP-2817778-B (pp. 4-5, FIGS. 4-8)

### SUMMARY

Since the optical module manufacturing method of Patent Document 1 uses a bonding tool for bonding the optical fiber and the silicon substrate together, it can be assumed that the silicon substrate is heated to 100° C. or higher. The heating by the bonding tool strains the silicon substrate and causes it to deform, and as a result, the optical axis of the optical fiber becomes misaligned with the optical element, resulting in a degradation of optical coupling efficiency.

Furthermore, since the Au film formed on the V-shaped groove of the silicon substrate and the Au film formed on the surface of the optical fiber are both flat in structure, the load applied to the Au films is distributed along the entire length of the V-shaped groove, and thus the applied load is insufficient, resulting in an inability to attain a desired bonding strength. Since the bonding strength between the Au films is weak, even if the semiconductor laser and the optical fiber can be aligned so as to achieve optimum optical coupling therebetween, it is difficult to maintain the optimum condition for an extended period of time.

It is an object of the present invention to provide an optical device and an optical device manufacturing method that can solve the above deficiencies.

More specifically, it is an object of the present invention to provide an optical device and an optical device manufacturing method wherein provisions are made to be able to precisely align an optical fiber relative to a substrate without heating the substrate and to maintain the optimum alignment condition for an extended period of time.

An optical device manufacturing method according to the invention includes the steps of forming a first metallic film on a portion of a substrate, forming a second metallic film on a portion of the outer circumference of an optical fiber, and bonding together the first metallic film and the second metallic film by surface activated bonding.

Preferably, the optical device manufacturing method further includes the step of forming a V-shaped groove in the surface, and the first metallic film is formed on the V-shaped groove.

Preferably, in the optical device manufacturing method, the first metallic film includes raised portions and recessed portions formed in a periodically repeating fashion along the longitudinal direction of the V-shaped groove, and the first metallic film is bonded to the second metallic film via the raised portions.

Preferably, in the optical device manufacturing method, the first metallic film includes openings formed in a periodically repeating fashion along the longitudinal direction of the V-shaped groove, and the first metallic film is bonded to the second metallic film at portions other than the openings.

Preferably, in the optical device manufacturing method, the first metallic film is formed in a stripe-shaped pattern that repeats in a periodic fashion along the longitudinal direction of the V-shaped groove.

Preferably, in the optical device manufacturing method, the second metallic film includes raised portions and recessed portions formed in a periodically repeating fashion along the longitudinal direction of the optical fiber, and the second metallic film is bonded to the first metallic film via the raised portions.

Preferably, in the optical device manufacturing method, the second metallic film includes openings formed in a periodically repeating fashion along the longitudinal direction of the optical fiber, and the second metallic film is bonded to the first metallic film at portions other than the openings.

Preferably, in the optical device manufacturing method, the second metallic film is formed in a stripe-shaped pattern that repeats in a periodic fashion along the longitudinal direction of the optical fiber.

Preferably, the optical device manufacturing method further includes the step of filling a bonding material into a gap created between the V-shaped groove and the optical fiber.

Preferably, in the optical device manufacturing method, the first metallic film, is formed on a datum plane surface of the substrate.

Preferably, the optical device manufacturing method further includes the step of fixing the optical fiber onto the substrate by using a reinforcing resin.

Preferably, in the optical device manufacturing method, the first metallic film is formed with micro-bumps.

Preferably, in the optical device manufacturing method, the first metallic film or the second metallic film is formed by laser processing a metallic film.

Preferably, in the optical device manufacturing method, the first metallic film or the second metallic film is formed by etching a metallic film.

An optical device according to the invention includes a first metallic film formed on a portion of a substrate, and a second metallic film formed on a portion of the outer circumference of an optical fiber, and wherein the optical fiber is fixedly bonded to the substrate with the first metallic film and the second metallic film bonded together by surface activated bonding.

According to the optical device and the optical device manufacturing method, the substrate and the optical fiber are fixedly bonded together by surface activated bonding that does not require heating for bonding. Accordingly, faults, such as optical axis misalignment due to the deformation of the substrate caused by heating, component breakage due to the residual stress arising from the difference in thermal expansion coefficient, and component functional degradation due to thermal stress, can be prevented from occurring.

According to the optical device and the optical device manufacturing method, it is possible to provide an optical device that achieves high optical coupling efficiency and high reliability by maintaining the optical coupling between the optical fiber and the matching optical element mounted on the same substrate in an optimum condition for an extended period of time.

According to the optical device and the optical device manufacturing method, by forming raised and recessed portions in the surface of the metallic film, the bonding strength at the contacting portions between the substrate and the optical fiber can be enhanced even when the applied load is small, because the load concentrates at the raised portions or the contacting portions other than the openings.

According to the optical device and the optical device manufacturing method, by forming raised and recessed portions in the surface of the metallic film, the adjustment range of the height of the optical fiber relative to the substrate can be enlarged, because it is possible to adjust the amount of compression of the metallic film over a wide range at the raised portions or portions other than the openings by varying the load,

### BRIEF DESCRIPTION OF THE DRAWINGS

These and other features and advantages of the present invention will be better understood by reading the following detailed description, taken together with the drawings wherein:

FIG. 1 is a perspective view schematically showing the structure of an optical device 1 before a substrate and an optical fiber are bonded together;

FIG. 2 is a perspective view schematically snowing the structure of the optical device 1 after the substrate and the optical fiber are bonded together;

FIG. 3(a) is a front view of the optical device 1, and FIG. 3(b) is a side view of the optical device 1 in the direction of arrow A in FIG. 3(a);

FIG. 4 is a process flow diagram. showing one example of a fabrication process for the optical device 1;

FIG. 5 is a perspective view schematically showing the structure of an alternative optical device 2 before the substrate and the optical fiber are bonded together;

FIG. 6(a) is a perspective view schematically showing the structure of the alternative optical device 2 after the substrate and the optical fiber are bonded together, and FIG. 6(b) is a side view in the direction of arrow C in FIG. 6(a);

FIG. 7 is a process flow diagram showing one example of a process step for forming raised and recessed portions by laser processing;

FIG. 8 is a process flow diagram showing one example of a process step for forming raised and recessed portions by etching;

FIGS. 9(a) and 9(b) are diagrams showing a bonding step for bonding the optical fiber 20 to the silicon substrate 10 in the optical device 2;

FIGS. 10(a), 10(b), and 10(c) are diagrams showing how the raised and recessed portions of a first metallic film formed on the V-shaped groove of the silicon substrate are deformed under an applied load;

FIGS. 11(a) and 11(b) are diagrams for explaining how the height of the optical fiber is adjusted;

FIG. 12 is a perspective view schematically showing the structure of a further alternative optical device 3 before the substrate and the optical fiber are bonded together;

FIG. 13(a) is a perspective view schematically showing the structure of the further alternative optical device 3 after the substrate and the optical fiber are bonded together, and FIG. 13(b) is a side view in the direction of arrow D in FIG. 13(a);

FIG. 14 is a perspective view schematically showing the structure of a further alternative optical device 4 before the substrate and the optical fiber are bonded together;

FIG. 15 is a diagram showing a further alternative optical device 5;

FIG. 16 is a diagram showing a further alternative optical device 6;

FIG. 17 is a diagram showing a further alternative optical device 7; and

FIG. 18 is a perspective view showing a further alternative optical device 100.

### DESCRIPTION OF EMBODIMENTS

An optical device and an optical device manufacturing method according to the present invention. will be described below with reference to the drawings. It will, however, be noted that the technical scope of the present invention is not limited to the specific embodiments described herein, but extends to the inventions described in the appended claims and their equivalents.

First, an overview of surface activated bonding will be given.

Surface activated bonding is a technique that activates material surfaces by removing inactive layers, such as oxides, dirt (contaminants), etc., from the surfaces using plasma or other means to activate the surface, and that bonds the surfaces together at normal temperatures by causing atoms having high surface energy to contact each other and by utilizing the adhesion forces acting between the atoms.

Oxide films, contaminants, etc., remain adhered to the actual surfaces (the surfaces of first and second metallic films in each embodiment). Therefore, plasma cleaning or ion-beam sputter etching is performed to activate the bonding surfaces, thus putting the bonding surfaces in an activated condition in which the atoms having bonds are exposed on the surfaces. In this condition, interatomic bonding can be accomplished by merely bringing the second metallic film formed on the optical fiber into contact with the first metallic film formed on the V-shaped groove of the silicon substrate,

Since this surface activated bonding does not require heating for bonding, the following advantages are offered.

1. Component breakage due to the residual stress arising from the difference in thermal expansion coefficient does not occur.

2. Since components are not subjected to thermal stress, component functional degradation does not occur.

3. Since the bonding is done in a solid phase without heating, component misalignment does not occur during mounting.

4. No thermal effects are caused to other components.

5. Since the atoms are directly bonded together, the bonding layer does not deteriorate over time.

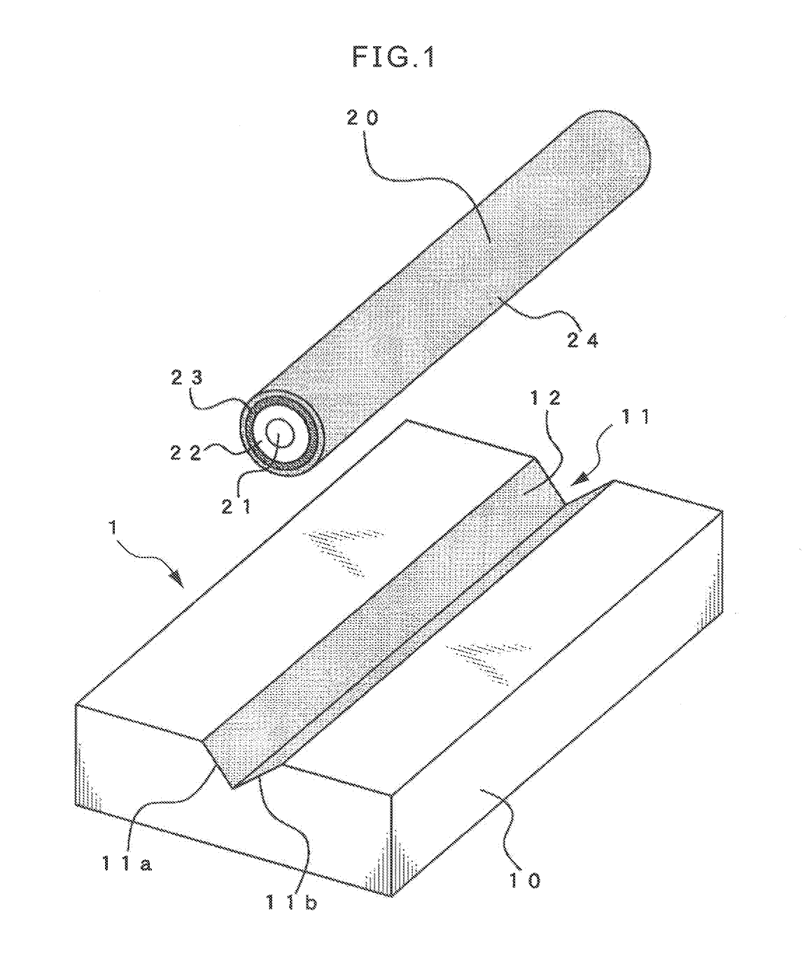

FIG. 1 is a perspective view schematically showing the structure of an optical device 1 before the substrate and the optical fiber are bonded together.

A V-shaped groove 11 having a prescribed width and length is formed in the surface of the silicon substrate 10. The surface of the V-shaped groove 11 is made up of two groove faces 11a and 11b formed opposite each other at a prescribed angle. A flat-patterned first metallic film 12 is formed to a prescribed thickness over the entire area of the two groove faces 11a and 11b. The material of the first metallic film 12 is Au (gold).

The optical fiber 20 includes a core layer 21 in the center, a clad layer 22 formed around the outer circumference of the core layer 21 and having a different refractive index, and a buffer layer 23 as a protective layer formed around the outer circumference of the clad layer 22. A flat-patterned second metallic film 24 is formed at a prescribed thickness around the outer circumference of the optical fiber 20 so as to cover the buffer layer 23. The material of the second metallic film 24 is also Au (gold).

The V-shaped aroove 11 of the silicon substrate 10 is formed in order to enable the optical fiber 20 to be positioned securely and bonded fixedly thereto; the width of the V-shaped groove 11 is determined according to the outer shape of the optical fiber 20 to be fitted therein, and the length of the V-shaped groove 11 is determined according to the specifications of the optical device.

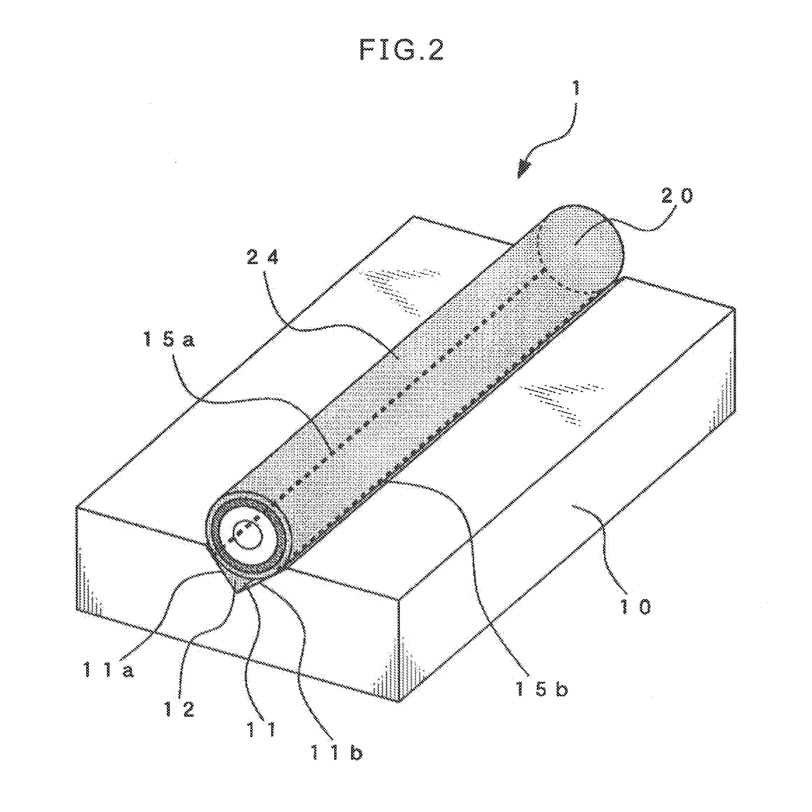

FIG. 2 is a perspective view schematically showing the structure of the optical device 1 after the substrate and the optical fiber are bonded together.

The optical fiber 20 is fitted into the V-shaped groove 11 of the silicon substrate 10 and pressed thereon under a prescribed load. Thereupon, the first metallic film 12 formed on the surface of the V-shaped groove 11 and the second metallic film 24 formed on the outer circumference of the optical fiber 20 are bonded together by surface activated bonding, and the optical fiber 20 is thus bonded fixedly to the silicon substrate 10.

The two aroove faces 11a and 11b of the V-shaped groove 11 of the silicon substrate 10 are flat faces, while the outer circumference of the optical fiber 20 is circular. Accordingly, two contacting portions 15a and 15b (in the figure, indicated by thick broken lines as if seen through the optical fiber 20), where the first metallic film 12 formed on the V-shaped groove 11 of the silicon substrate 10 contacts the second metallic film 24 formed on the outer circumference of the optical fiber 20, are formed extending in straight lines along the longitudinal direction of the respective groove faces 11a and 11b (in line-contacting fashion). The structure formed by fixedly bonding the silicon substrate 10 and the optical fiber 20 in integral fashion as shown in FIG. 2 is the optical device 1 manufactured by the manufacturing method to be described later.

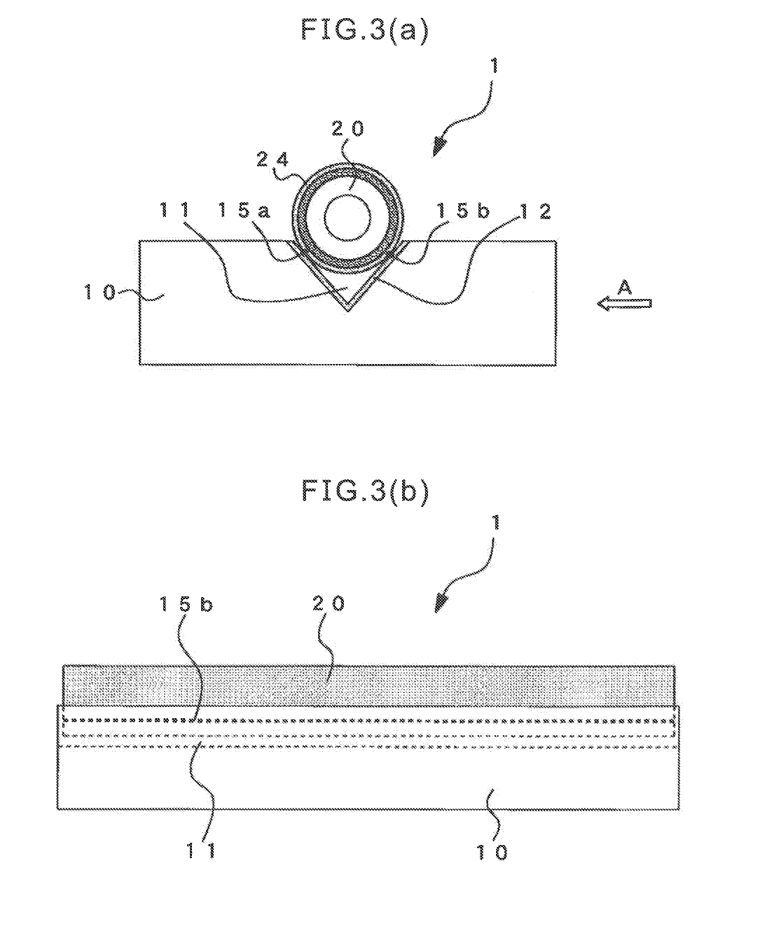

FIG. 3(a) is a front view of the optical device 1, and FIG. 3(b) is a side view of the optical device 1 in the direction of arrow A in FIG. 3(a).

Since the optical fiber 20 is fitted into the V-shaped groove 11 of the silicon substrate 10 and bonded fixedly thereto, as shown in FIG. 3(a), the position of the optical fiber 20 relative to the silicon substrate 10 does not become displaced, and the optical fiber 20 remains securely and fixedly bonded to the silicon substrate 10. More specifically, the optical fiber 20 fitted into the V-shaped groove 11 of the silicon substrate 10 is fixedly bonded to it in such a manner as to be held by the two contacting portions 15a and 15b.

As shown in FIG. 3(b), the optical fiber 20 is fixedly bonded along the longitudinal direction thereof with a portion of the optical fiber 20 embedded in the V-shaped groove 11 of the silicon substrate 10. Further, since the contacting portion 15b (the contacting portion 15a is not shown in FIG. 3(b)) is formed extending in a straight line along the longitudinal direction of the optical fiber 20 and the V-shaped groove 11, the optical fiber 20 is securely and fixedly bonded along the entire length of the V-shaped groove 11.

Furthermore, since the optical fiber 20 is bonded to the silicon substrate 10 in a line-contacting fashion so as to be held by the two contacting portions 15a and 15b, the load applied to press the optical fiber 20 is concentrated on the line contacting portions 15a and 15b. As a result, the first metallic film 12 of the silicon substrate 10 and the second metallic film 24 of the optical fiber 20 can be bonded together by surface activated bonding under a relatively small load.

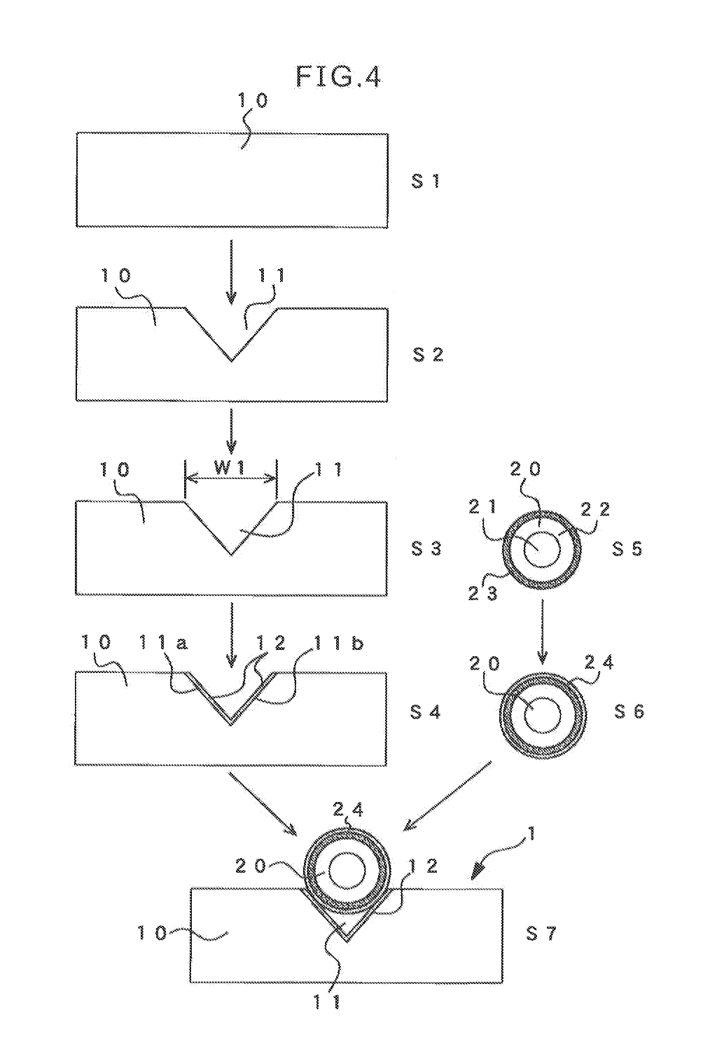

FIG. 4 is a process flow diagram showing one example of a fabrication process for the optical device 1.

The process flow diagram of FIG. 4 shows the optical device 1 as seen from the same direction as the front view of the optical device 1 (see FIG. 3(a)). The process flow diagram of FIG. 4 is also applicable to an alternative fabrication process to be described later.

One feature of the manufacturing method of the optical device 1 is that the first metallic film formed on the V-shaped groove of the substrate and the second metallic film formed on the outer circumference of the optical fiber are both of a flat pattern and are bonded together by surface activated bonding.

First, the silicon substrate 10 having a prescribed thickness and treated with necessary processing is prepared (silicon substrate fabrication step S1).

Next, the V-shaped groove 11 with a prescribed angle is formed in the surface of the silicon substrate 10 by anisotropic etching (V-shaped groove forming step S2). The V-shaped groove 11 may be formed by laser processing or machining, instead of etching.

Next, the width W1 of the V-shaped groove 11 formed in the V-shaped groove forming step S2 is measured to determine whether the V-shaped groove 11 has been formed to the desired size (V-shaped groove measuring step S3). The V-shaped groove measuring step S3 is performed in order to adjust the width of the V-shaped groove 11 and thereby adjust the height of the optical axis of the optical fiber 20 relative to the surface of the silicon substrate 10.

The height of the optical axis of the optical fiber 20 relative to the surface of the silicon substrate 10 must be adjusted to align the optical axis of the optical fiber 20 with the optical axis of a matching optical element (for example, a semiconductor laser). For this purpose, the width W1 of the V-shaped groove 11 is measured to compute the height of the optical axis of the optical fiber 20 to be fitted into the V-shaped groove 11. If it is determined that the V-shaped groove 11 has been formed to the desired width W1, the process proceeds to the next step; otherwise, the process returns to the V-shaped groove forming step S2 to additionally process the V-shaped groove 11.

In practice, the V-shaped groove 11 is formed to a width slightly smaller than the desired width W1 so that the optical axis of the optical fiber 20 is set slightly higher than the desired height (at which the optical axis of the optical fiber 20 coincides with the optical axis of the matching optical element). Then, by adjusting the amount of compression of the metallic film while varying the load to be applied for bonding, the height of the optical axis of the optical fiber 20 is fine-adjusted for optical axis alignment, as will be described later.

Next, the first metallic film 12 of Au is formed to a prescribed thickness over the two groove faces 11a and 11b of the V-shaped groove 11 formed in the surface of the silicon substrate 10 (first metallic film forming step S4). The first metallic film 12 is formed by such means as vapor deposition or plating.

Next, the optical fiber 20 is prepared (optical fiber fabrication step S5). The optical fiber 20 is made up of the core layer 21, clad layer 22, and buffer layer 23. The buffer layer 23 is provided to enhance the adhesion and hermeticity of the silica-based optical fiber relative to the second metallic film 24 in order to produce a metallized fiber by coating the surface of the optical fiber 20 with the second metallic film. The buffer layer 23 can be formed from a single layer of an Ni-plated film or Ti-sputtered film or from a metallic layer of a two-layered structure formed by depositing an Ni-plated or Ni-sputtered film on top of a Ti-sputtered film.

Next, the second metallic film 24 of Au is formed to a prescribed thickness around the outer circumference of the optical fiber 20 (second metallic film forming step S6). The second metallic film 24 is formed by such means as sputtering, vapor deposition, or plating.

Next, before bonding the optical fiber 20 to the silicon substrate 10, the first metallic film 12 formed on the V-shaped groove 11 of the silicon substrate 10 and the second metallic film 24 formed around the outer circumference of the optical fiber 20 are cleaned with argon plasma to activate their surfaces. After that, the optical fiber 20 coated with the second metallic film 24 is fitted into the V-shaped groove 11 of the silicon substrate 10 coated with the first metallic film 24, and the two members are pressed together under a prescribed load, thereby bonding the first metallic film 12 and the second metallic film 24 by surface activated bonding (bonding step S7). The optical fiber 20 is thus bonded fixedly to the silicon substrate 10, completing the fabrication of the optical device 1 with the optical fiber 20 mounted on the silicon substrate 10.

After the bonding step S7 and/or a subsequent fine-adjusting step, the optical fiber 20 is optically coupled to other optical elements (semiconductor laser, wavelength conversion element, etc.) (not shown) in a suitable manner. Preferably, other optical elements are properly positioned on the silicon substrate 10 and fixed to it in advance.

According to the optical device manufacturing method described above, the silicon substrate 10 and the optical fiber 20 are bonded together by surface activated bonding that does not require heating for bonding. Accordingly, faults, such as optical axis misalignment due to the deformation of the substrate caused by heating, component breakage due to the residual stress arising from the difference in thermal expansion coefficient, and component functional degradation due to thermal stress, can be prevented from occurring. It is thus possible to provide an optical device that achieves high optical coupling efficiency and high reliability by maintaining the optical coupling between the optical fiber and its matching optical element in an optimum condition for an extended period of time. Furthermore, in the optical device 1, since the first metallic film 12 and the second metallic film 24 are both of a flat pattern, the formation of the metallic films is simple, which offers the advantage of being able to simplify the optical device fabrication process.

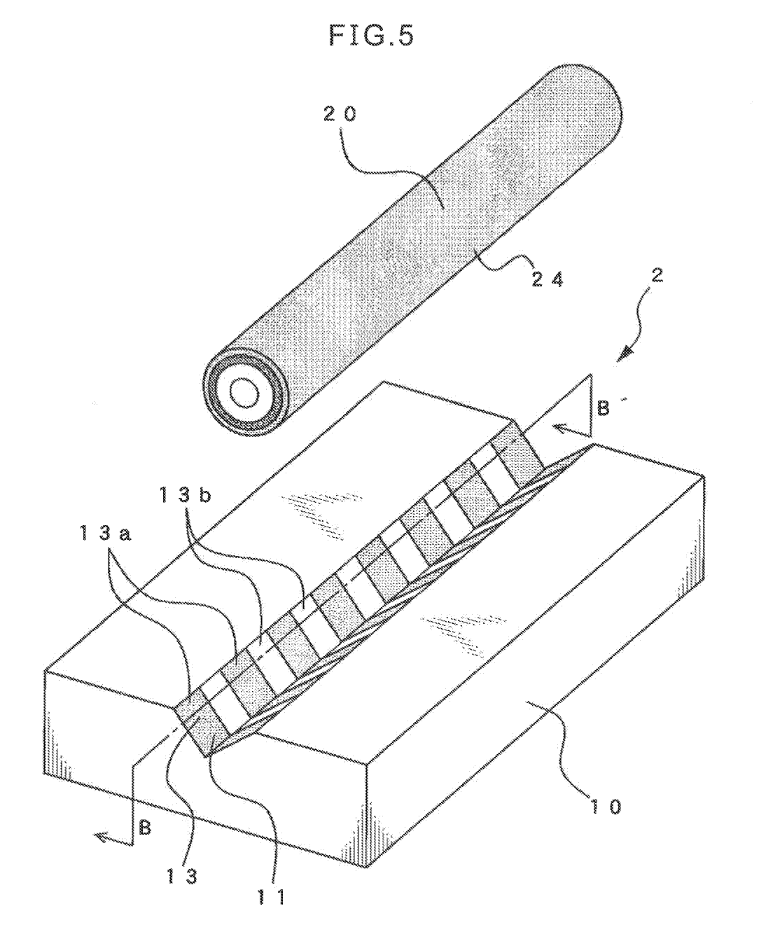

FIG. 5 is a perspective view schematically showing the structure of an alternative optical device 2 before the substrate and the optical fiber are bonded together. In FIG. 5, the same component elements as those in FIG. 1 are designated by the same reference numerals, and the description of such component elements will not be repeated here.

As shown in FIG. 5, the V-shaped groove 11 having a prescribed width and length is formed in the surface of the silicon substrate 10, and a first metallic film 13 with stripe-shaped raised and recessed portions formed in a periodically repeating fashion along the longitudinal direction of the V-shaped groove 11 is formed on the surface of the V-shaped groove 11. The material of the first metallic film 13 is Au.

In the figure showing the stripe-shaped raised and recessed portions of the first metallic film 13, the portions lightly shaded are the raised portions 13a, and the portions not shaded are the recessed portions 13b. The thickness of the first metallic film 13 differs between the raised portions 13a and the recessed portions 13b; i.e., the portions where the metallic film (Au) is thick are the raised portions 13a, and the portions where the metallic film (Au) is thin are the recessed portions 13b. The raised portions 13a and the recessed portions 13b are formed in a stripe-shaped pattern repeating in a periodic fashion along the longitudinal direction of the V-shaped groove 11. The recessed portions 13b may be formed by removing the metallic film and exposing the surface of the silicon substrate 10. In this case, the first metallic film 13 is formed only from the raised portions 13a.

The optical fiber 20 is the same as used in the optical. device 1 and will not be described in detail, except that the outer circumference of the optical fiber 20 is coated with the flat-patterned second metallic film 24. The material of the second metallic film 24 is Au. Cross section line B-B′ will be described later.

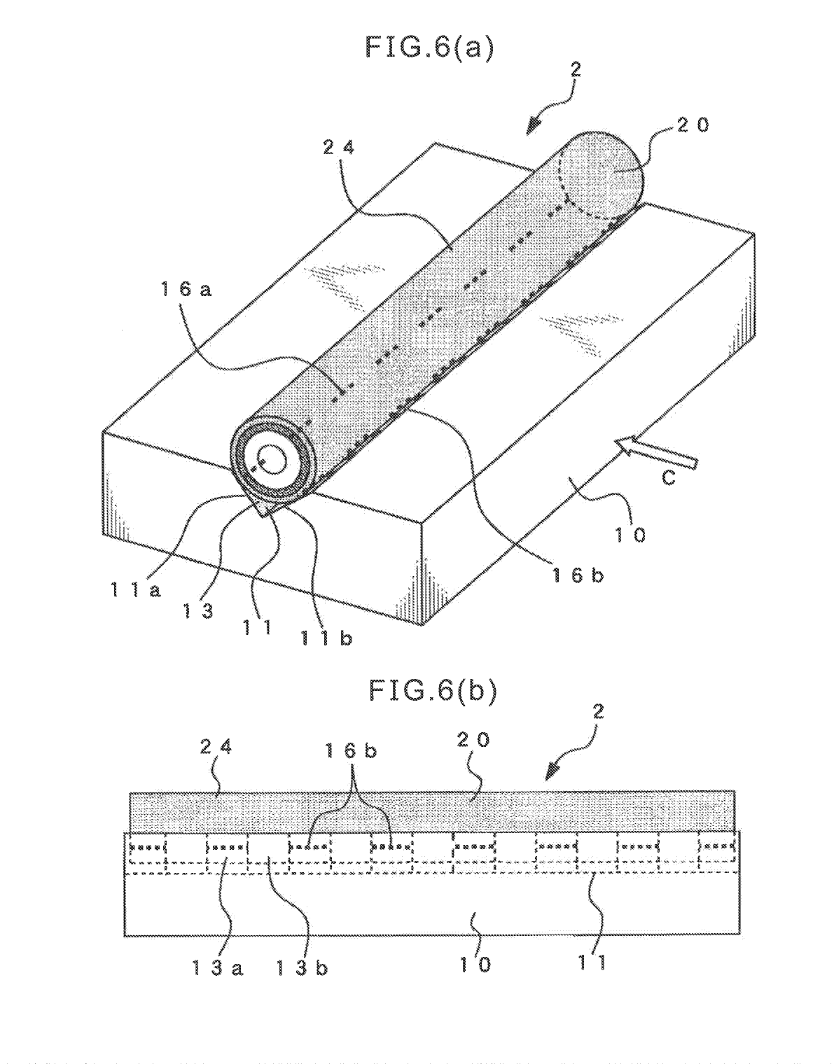

FIG. 6(a) is a perspective view schematically showing the structure of the alternative optical device 2 after the substrate and the optical fiber are bonded together, and FIG. 6(b) is a side view in the direction of arrow C in FIG. 6(a).

As shown in FIGS. 6(a) and 6(b), the optical fiber 20 is fitted into the V-shaped groove 11 of the silicon substrate 10 and pressed thereon under a prescribed load. Thereupon, the first metallic film 13 having raised and recessed portions formed on the surface of the V-shaped groove 11 and the flat-patterned second metallic film 24 formed on the outer circumference of the optical fiber 20 are bonded together by surface activated bonding, and the optical fiber 20 is thus bonded fixedly to the silicon substrate 10.

The two groove faces 11a and 11b of the V-shaped groove 11 of the silicon substrate 10 are flat faces, while the outer circumference of the optical fiber 20 is circular. Accordingly, two contacting portions 16a and 16b (in the figure, indicated by thick broken lines as if seen through the optical fiber 20), where the first metallic film 13 formed on the V-shaped groove 11 of the silicon substrate 10 contacts the second metallic film 24 formed on the outer circumference of the optical fiber 20, are formed at prescribed intervals in a discontinuous manner along the longitudinal direction of the respective groove faces 11a and 11b.

Since the first metallic film 13 on the V-shaped groove 11 is provided with the stripe-shaped raised and recessed portions formed in a periodically repeating fashion, as earlier described, the second metallic film 24 of the optical fiber 20 contacts the first metallic film 13 only at the raised portions 13a thereof and does not contact at the recessed portions 13b. Accordingly, the two contacting portions 16a and 16b are each located in a discontinuous manner in the regions of the raised portions 13a formed in a periodically repeating fashion.

As shown in FIG. 6(b), in the optical device 2, as in the optical device 1, the optical fiber 20 is fixedly bonded along the longitudinal direction thereof with a portion of the optical fiber 20 embedded in the V-shaped groove 11 of the silicon substrate 10. Therefore, the contacting portion 16b (in the figure, the contacting portion 16a is not shown) is formed at prescribed intervals in a discontinuous manner along the longitudinal direction of the optical fiber 20 and the V-shaped groove 11.

In this way, the optical fiber 20 in the optical device 2 contacts the silicon substrate 10 at the discontinuously formed contacting portions 16a and 16b, i.e., the raised portions 13a formed in a periodically repeating fashion. Accordingly, in the optical device 2, the contact is close to a multiple-point contact, and therefore, the contact area is much smaller than in the case of the optical device 1. As a result, since the load applied when bonding the optical fiber 20 to the silicon substrate 10 is further concentrated at the contacting portions 16a and 16b that are close to point contacts, the silicon substrate 10 and the optical fiber 20 can be bonded together by surface activated bonding under a load smaller than that required in the case of the optical fiber 1.

In the optical device 2, if approximately the same load as that used in the bonding step of the optical device 1 is applied for bonding, the bonding strength can be further increased, since the large load concentrates at the contacting portions 16a and 16b. The structure formed by fixedly bonding the silicon substrate 10 and the optical fiber 20 in integral fashion as shown in FIG. 6 is the optical device 2 manufactured by the manufacturing method to be described later.

In FIG. 5, the stripe-shaped raised and recessed portions 13a and 13b of the first metallic film 13 are each shown as being formed across the entire width of the interior surface of the V-shaped groove 11, but alternatively, the raised and recessed portions 13a and 13b may be formed only at and near the contacting portions 16a and 16b that contact the second metallic film 24 of the optical fiber 20. In that case, the regions other than the contacting portions 16a and 16b may be covered with a flat-patterned metallic film or may not be covered with any metallic film. That is, the raised and recessed portions of the first metallic film 13 need only be formed along the contacting portions 16a and 16b that contact the second metallic film 24 of the optical fiber 20. Furthermore, the raised and recessed portions of the first metallic film 13 need not necessarily be formed in a stripe pattern, but may be formed in any suitable pattern, the only requirement is that the raised and recessed portions be formed in a periodically repeating fashion.

The fabrication process of the optical device 2 is the same as the fabrication process of the optical device 1 described earlier (see FIG. 4), except the step for forming the raised and recessed portions in the first metallic film 13 of the silicon substrate 10 and the bonding step for bonding the optical fiber 20 to the silicon substrate 10; therefore, the other steps will not be further described herein. The step for forming the raised and recessed portions in the first metallic film forming step S4 of FIG. 4 will be described in detail below.

One feature of the manufacturing method of the optical device 2 is that the first metallic film formed on the V-shaped groove of the substrate, with the stripe-shaped raised and recessed portions formed in a periodically repeating fashion, and the second metallic film formed on the outer circumference of the optical fiber are bonded together by surface activated bonding.

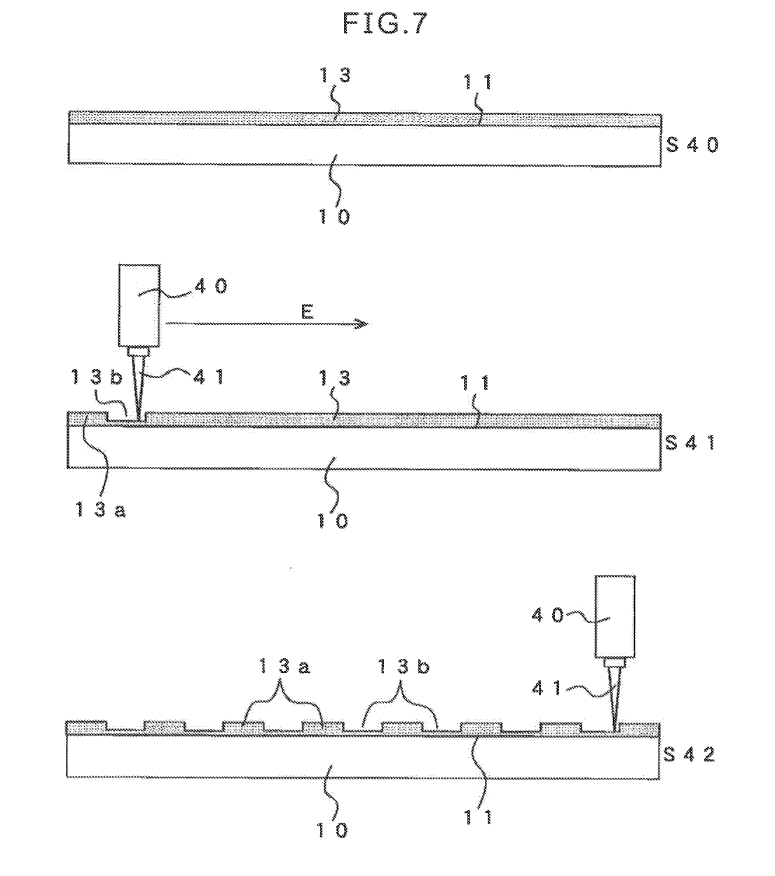

FIG. 7 is a process flow diagram showing one example of the step for forming the raised and recessed portions by laser processing. A cross-sectional view taken along line B-B′ in FIG. 5 is shown in FIG. 7. Since the step of forming the raised and recessed portions is a step added to the first metallic film forming step S4 in the fabrication process shown in FIG. 4, the sequence of process steps will be described below as steps S40 to S42.

First, the V-shaped groove 11 is formed by anisotropic etching in the surface of the silicon substrate 10 planarized by a CMOS-LSI forming process, etc., and the first metallic film 13 is formed by uniformly depositing Au by vapor deposition on the surface of the V-shaped groove 11 (first metallic film forming step S40). The V-shaped groove 11 may be formed by a method other than anisotropic etching, and the first metallic film 13 may be formed by a method other than vapor deposition.

Next, the raised and recessed portions are formed in the surface of the first metallic film 13 by laser processing (laser processing start step S41). To form the stripe-shaped raised and recessed portions in a periodically repeating fashion along the longitudinal direction of the V-shaped groove of the silicon substrate 10, laser light 41 is repeatedly radiated for a predetermined period of time while moving a laser processing tool 40 along the longitudinal direction (arrow E) of the V-shaped groove 11, thereby removing a portion of Au from the surface of the first metallic film 13 to reduce the thickness of that portion. Regions irradiated with the laser light 41 form the recessed portions 13b, and regions not irradiated with the laser light 41 form the raised portions 13a.

Next, the laser light 41 is repeatedly radiated while moving the laser processing tool 40 and, when the laser processing tool 40 reaches the end of the longitudinal direction of the V-shaped groove 11, and the raised portions 13a and the recessed portions 13b are formed in a periodically repeating fashion over the entire area of the V-shaped groove 11, the laser processing step ends (laser processing end step S42). By thus carrying out the laser processing start step S41 and the laser processing end step S42, the raised portions 13a where the thickness of the first metallic film 13 is retained and the recessed portions 13b where the thickness of the first metallic film 13 is reduced by laser processing are formed in a stripe-shaped pattern in the surface of the V-shaped groove 11 of the silicon substrate 10. The depth of the recessed portions 13b can be adjusted by varying the radiation time, etc., of the laser light 41.

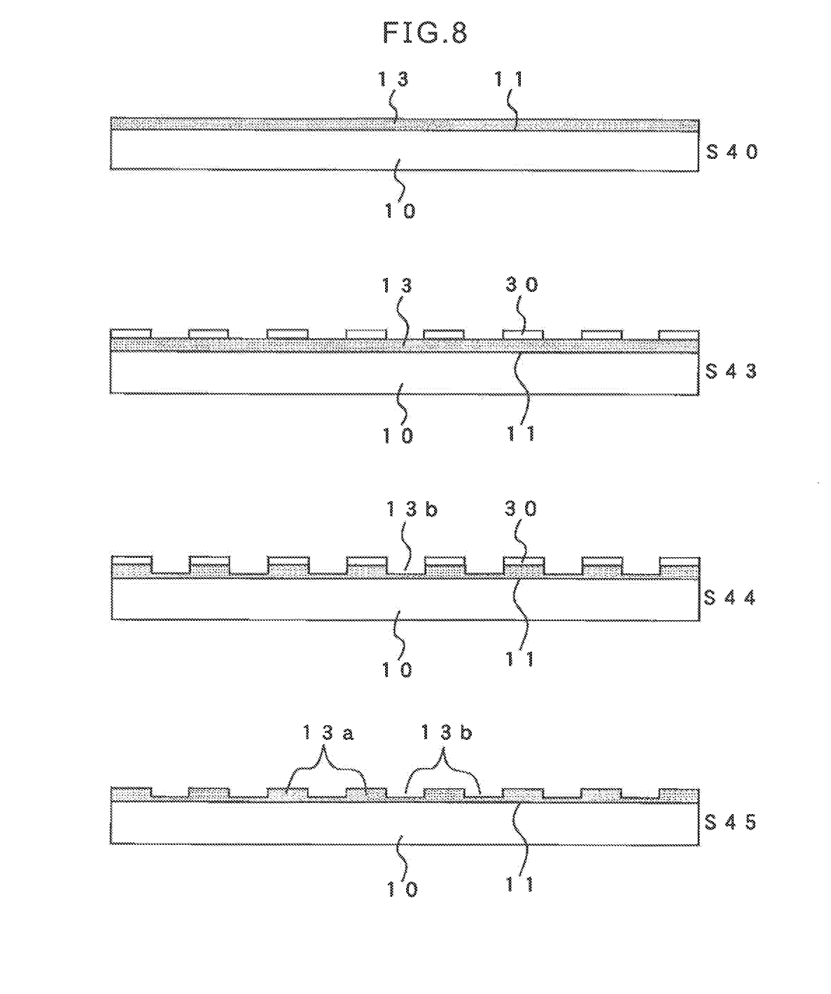

FIG. 8 is a process flow diagram showing one example of the step for forming the raised and recessed portions by etching. A cross-sectional view taken along line B-B′ in FIG. 5 is shown in FIG. 8. Since the step of forming the raised and recessed portions is a step added to the first metallic film forming step S4 in the fabrication process shown in FIG. 4, the sequence of process steps will be described below as steps S43 to S45. The process shown in FIG. 8 can be used instead of the process shown in FIG. 7.

First, the V-shaped groove 11 is formed by anisotropic etching in the surface of the silicon substrate 10 planarized by a CMOS-LSI forming process, etc., and the first metallic film 13 is formed by uniformly depositing Au by vapor deposition on the surface of the V-shaped groove 11 (first metallic film forming step S43). The V-shaped groove 11 may be formed by a method other than anisotropic etching, and the first metallic film 13 may be formed by a method other than vapor deposition.

Next, a resist film 30 for forming the raised and recessed portions is formed on the surface of the first metallic film 13 (resist forming step S43). To form the stripe-shaped raised and recessed portions in a periodically repeating fashion along the longitudinal direction of the V-shaped groove 11 of the silicon substrate 10, the resist film 30 is formed in a pattern of periodically repeating stripes so as to cover the regions where the raised portions are to be formed but not cover the regions where the recessed portions are to be formed.

Next, the portions of the first metallic film 13 that are not covered with the resist film 30 are etched (etching step S44). The thus etched portions form the recessed portions 13b.

Next, the resist film 30 is removed (resist removing step S45). Since the portions covered with the resist film 30 remain unetched, the original thickness of the first metallic film 13 is retained in the unetched portions which thus form the raised portions 13a. In this way, the raised portions 13a where the thickness of the first metallic film 13 is retained and the recessed portions 13b where the thickness of the first metallic film 13 is reduced by etching are formed on the surface of the V-shaped groove 11 of the silicon substrate 10. The depth of the recessed portions 13b can be adjusted by varying the etching time, etc.

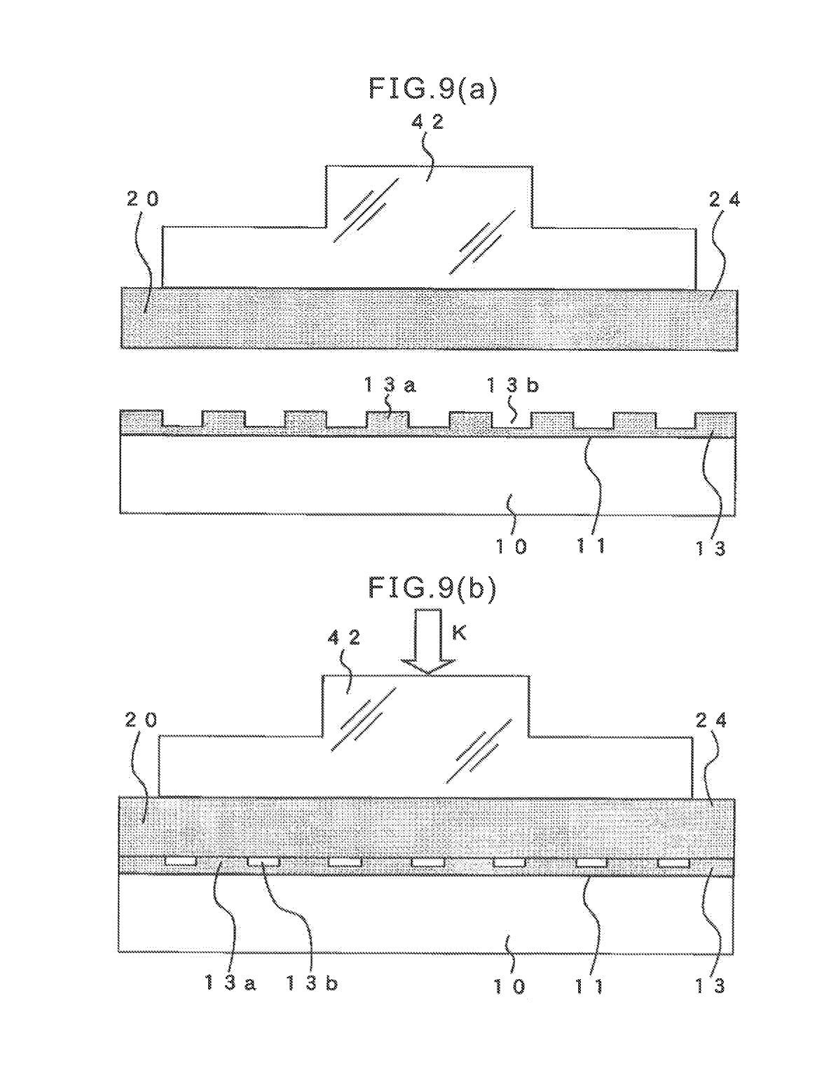

FIGS. 9(a) and 9(b) are diagrams showing the bonding step for bonding the optical fiber 20 to the silicon substrate 10 in the optical device 2.

As shown in FIG. 9(a), the first metallic film 13 is formed on the surface of the V-shaped groove 11 of the silicon substrate 10, and the raised portions 13a and the recessed portions 13b are formed in the first metallic film 13 in a periodically repeating fashion along the longitudinal length of the V-shaped groove 11.

The flat-patterned second metallic film 24 is formed around the outer circumference of the optical fiber 20. A pressing tool 42 is pressed onto the optical fiber 20 from the top in the figure. Preferably, the pressing tool 42 has such a structure as no press the optical fiber 20 substantially along the entire length of the V-shaped groove 11 of the silicon substrate 10. With this structure, the optical fiber 20 can be pressed uniformly along the entire length of the V-shaped groove 11 of the silicon substrate 10.

With the pressure applied by the pressing tool 42, the first metallic film 13 formed on the silicon substrate 10 and the second metallic film 24 formed on the optical fiber 20 are bonded together by the surface activation method described earlier. Before bonding, the first metallic film 13 and the second metallic film 24 are cleaned with argon plasma (not shown) to activate their surfaces.

Next, the optical fiber 20 is positioned and fitted into the V-shaped groove 11 of the silicon substrate 10, as shown in FIG. 9(b), and a prescribed load K is applied to the optical fiber 20 by means of the pressing tool 42. As the load is thus applied, the first metallic film 13 formed on the silicon substrate 10 and the second metallic film 24 formed on the optical fiber 20 are bonded together by surface activated bonding.

As described above, the raised portions 13a and the recessed portions 13b are formed in the first metallic film 13 on the surface of the V-shaped groove 11 of the silicon substrate 10. Accordingly, when the optical fiber 20 is fitted into the V-shaped groove 11 and pressed thereon, the second metallic film 24 formed on the outer circumference of the optical fiber 20 contacts the first metallic film 13 only at the raised portions 13a thereof. Since the load K from the optical fiber 20 concentrates at the raised portions 13a, the Au in the raised portions 13a and the Au in the second metallic film 24 contacting the raised portions 13a are bonded together by interatomic bonding at normal temperatures even when the applied load is relatively small. The optical fiber 20 is thus bonded fixedly to the silicon substrate 10 by surface activated bonding.

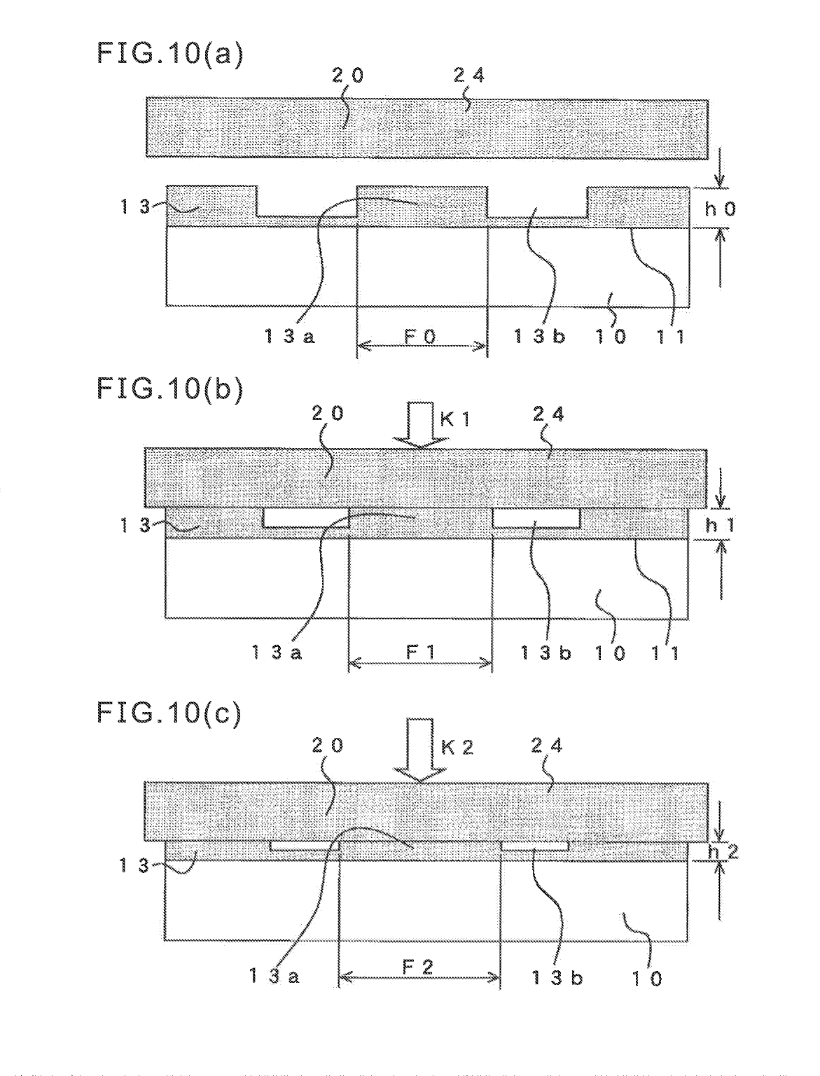

FIG. 10 is a diagram showing how the raised and recessed portions of the first metallic film formed on the V-shaped groove of the silicon substrate are deformed under an applied load. FIG. 10 is a side view showing a portion of the side view of FIG. 9 in enlarged form.

FIG. 10(a) shows the condition before the optical fiber 20 is pressed onto the silicon substrate 10. In FIG. 10(a), the height of the raised portions 13a of the first metallic film 13 formed on the surface of the V-shaped groove 11 of the silicon snbstrate 10 is denoted by h0, and the width of each raised portion 13a is denoted by F0.

As shown in FIG. 10(b), when the optical fiber 20 is pressed by the pressing tool 42 (see FIG. 9) onto the V-shaped groove 11 of the silicon substrate 10 under a load K1, the second metallic film 24 of the optical fiber 20 contacts the raised portions 13a of the first metallic film 13, and thus the raised portions 13a are pushed downward. Since the raised portions 13a are compressed and deformed under pressure and spread into the adjacent recessed portions 13b, the height of the raised portions 13a is reduced (to height h1) while the width of each raised portion 13a is enlarged (to width F1).

In the case of FIG. 10(b), the optical fiber 20 is bonded fixedly to the silicon substrate 10 by surface activated bonding under the pressure of the load applied by the pressing tool 42; since the raised portions 13a of the first metallic film 13 are maintained in the compressed condition, the height of the raised portions 13a is held at h1.

FIG. 10(c) shows the condition in which the optical fiber 20 is pressed by the pressing tool 42 (see FIG. 9) onto the V-shaped groove 11 of the silicon substrate 10 under a load K2 which is larger than the load K1. In this case, since the raised portions 13a are further compressed and deformed under pressure and spread into the adjacent recessed portions 13b, the height of the raised portions 13a is further reduced (to height h2) while the width of each raised portion 13a is further enlarged (to width F2).

In the case of FIG. 10(c), the optical fiber 20 is bonded fixedly to the silicon substrate 10 by surface activated bonding under the pressure of the load applied by the pressing tool 42; since the raised portions 13a of the first metallic film 13 are maintained in the compressed condition, the height of the raised portions 13a is held at h2.

In this way, the silicon substrate 10 and the optical fiber 20 are bonded together by surface activated bonding at normal temperatures under the pressure of the prescribed load applied thereto. Further, by adjusting the magnitude of the load to be applied to the optical fiber 20 for bonding, the height h of the raised portions 13a of the first metallic film 13 can be varied. The fact that the height h of the raised portions 13a of the first metallic film 13 can be varied means that the height of the optical fiber 20 relative to the silicon substrate 10 can be adjusted. This in turn means that the optical axis of the optical fiber 20 can be precisely aligned with the optical axis of the matching optical element (such as the semiconductor laser) mounted on the same silicon substrate 10.

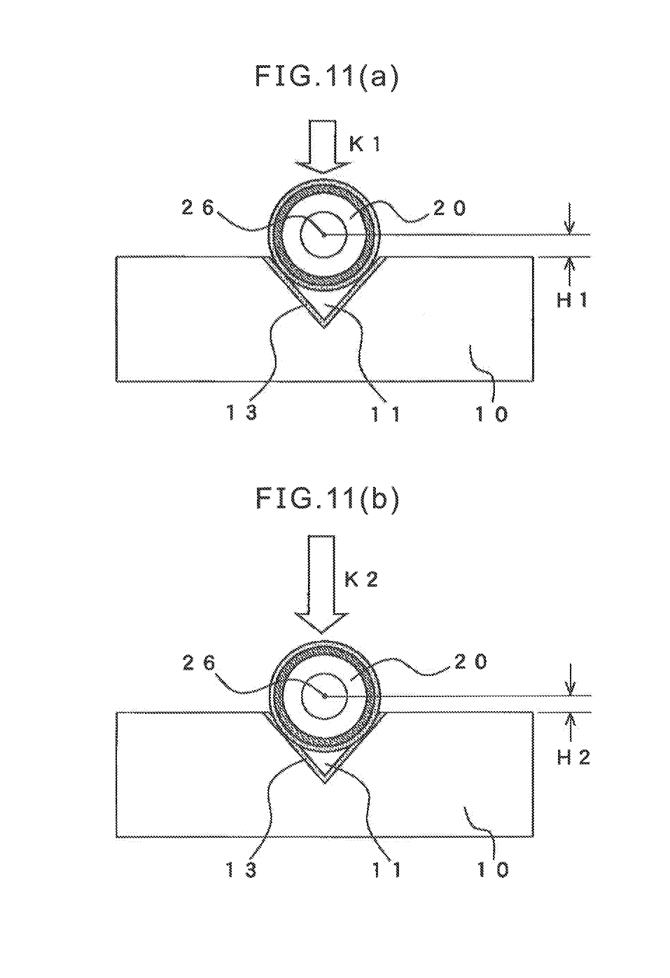

FIG. 11 is a diagram for explaining how the height of the optical fiber is adjusted.

When the optical fiber 20 is pressed onto the V-shaped groove 11 of the silicon substrate 10 under the relatively small load K1, as shown in FIG. 11(a), the amount of compression of the raised portions 13a of the first metallic film 13 (see FIG. 10) is relatively small. Accordingly, the height H1 from the surface of the silicon substrate 10 to the optical axis 26 at the center of the optical fiber 20 is relatively high.

On the other hand, when the optical fiber 20 is pressed onto the V-shaped groove 11 of the silicon substrate 10 under the relatively large load K2, as shown in FIG. 11(b) , the amount of compression of the raised portions 13a of the first metallic film 13 (see FIG. 10) increases. Accordingly, the height H2 from the surface of the silicon substrate 10 to the optical axis 26 at the center of the optical fiber 20 is relatively low.

In this way, by varying the magnitude of the load applied to effect the surface activated bonding of the silicon substrate 10 and the optical fiber 20, the height H of the optical axis 26 of the optical fiber 20 relative to the silicon substrate 10 can be adjusted as desired. Since the height of the optical fiber 20 can be adjusted by varying the magnitude of the load, the optical axis can be highly precisely aligned with the optical axis of the matching optical element mounted on the same silicon substrate 10. It is thus possible to manufacture a high-performance optical device that can adjust the optical coupling between the optical elements to an optimum condition and that can maintain the optimum condition for an extended period of time.

In the case of the optical device 1 shown in FIGS. 1 to 4 in which the flat-patterned metallic films are bonded together, it is also possible to adjust the height of the optical fiber 20 by varying the magnitude of the load. However, in the case of the optical device 2 shown in FIGS. 5 to 10 in which one of the metallic films is formed with raised and recessed portions, the contact portions close to point contacts are formed, and the load can therefore be concentrated at the raised portions 13a. Furthermore, when the raised portions 13a are compressed and deformed under the pressure of the load, the Au forming each raised portion 13a is allowed to spread into its adjacent recessed portions 13b, thus making it possible to increase the amount by which the raised portion 13a is compressed. Accordingly, in the case of the optical device 2, the range over which the height of the optical axis of the optical fiber 20 can be adjusted by the compression of the raised portions 13a by varying the magnitude of the load can be enlarged compared with the case of the optical device 1.

As a result, in the optical device 2, if the amount of misalignment between the optical fiber 20 and the optical axis of its matchind optical element is relatively large, the height of the optical axis of the optical fiber 20 can be adjusted by an amount large enough to correct such an alignment error; in this way, a high-performance optical device having high optical coupling efficiency can be achieved.

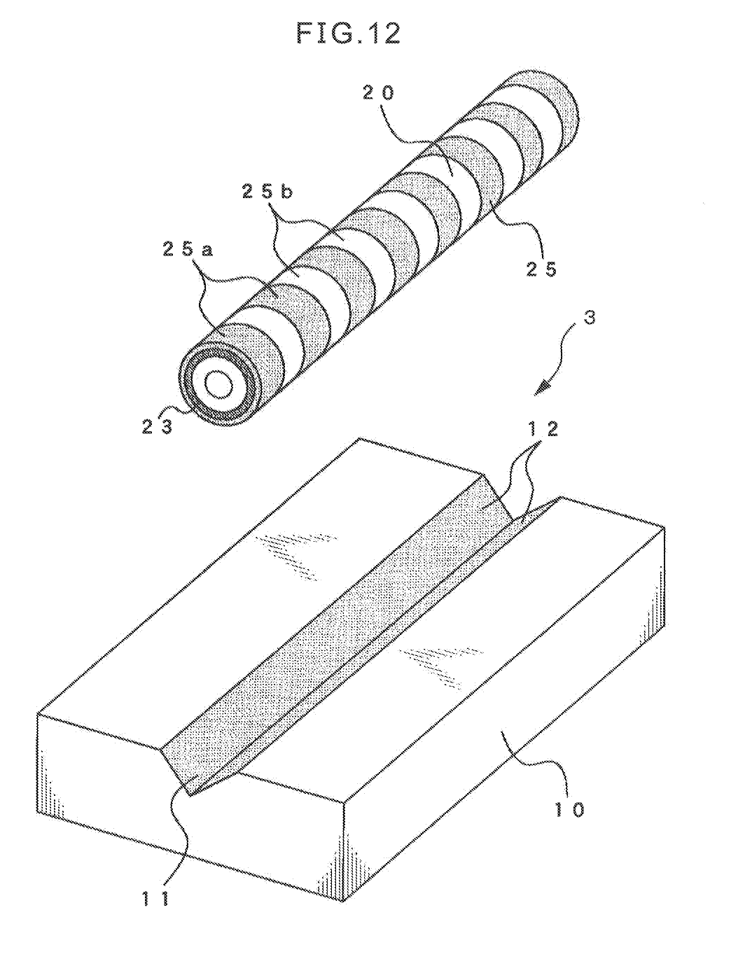

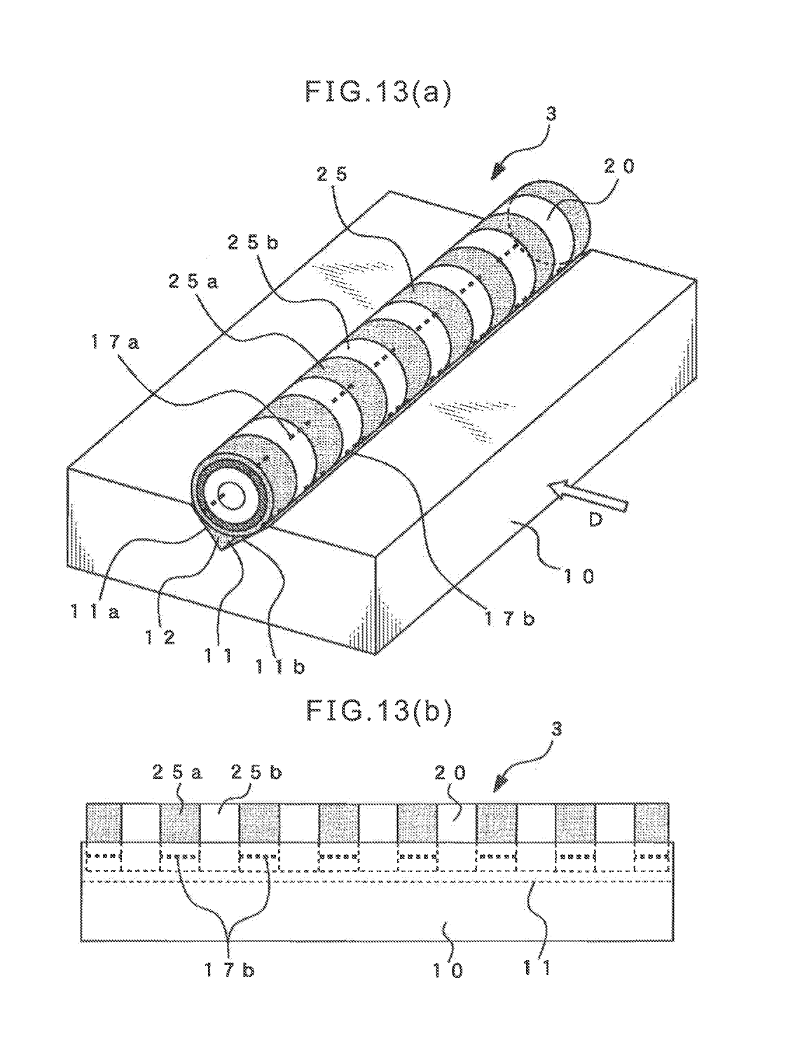

FIG. 12 is a perspective view schematically showing the structure of a further alternative optical device 3 before the substrate and the optical fiber are bonded together. In FIG. 12, the same component elements as those in FIG. 1 are designated by the same reference numerals, and the description of such component elements will not be repeated.

In FIG. 12, the V-shaped groove 11 having a prescribed width and length is formed in the surface of the silicon substrate 10, and the flat-patterned first metallic film 12 is formed on the surface of the V-shaped groove 11, as in the case of the optical device 1. The material of the first metallic film 13 is Au.

A second metallic film 25 with stripe-shaped raised and recessed portions formed in a periodically repeating fashion along the longitudinal direction of the optical fiber 20 is formed around the outer circumference of the optical fiber 20. The material of the second metallic film 25 is Au.

In the figure showing the stripe-shaped raised and recessed portions of the second metallic film 25, the portions lightly shaded are the raised portions 25a, and the portions not shaded are the recessed portions 25b. The thickness of the second metallic film 25 differs between the raised portions 25a and the recessed portions 25b; i.e., the portions where the metallic film (Au) is thick are the raised portions 25a, and the portions where the metallic film (Au) is thin are the recessed portions 25b. The raised portions 25a and the recessed portions 25b are formed in a stripe-shaped pattern repeating in a periodic fashion along the longitudinal direction of the optical fiber 20.

According to the pattern of the second metallic film 25, the stripe-shaped raised and recessed portions of the second metallic film 25 can be made to contact the V-shaped groove 11 of the silicon substrate 10, regardless of how the optical fiber 20 is rotated relative to the silicon substrate 10. The recessed portions 25b may be formed by removing the second metallic film 25 and exposing the underlying buffer layer 23 of the optical fiber 20. In this case, the second metallic film 25 is formed only from the raised portions 25a.

FIG. 13(a) is a perspective view schematically showing the structure of the further alternative optical device 3 after the substrate and the optical fiber are bonded together, and FIG. 13(b) is a side view in the direction of arrow D in FIG. 13(a).

As shown in FIGS. 13(a) and 13(b), the optical fiber 20 is fitted into the V-shaped groove 11 of the silicon substrate 10 and pressed thereon under a prescribed load. Thereupon, the flat-patterned first metallic film 12 formed on the surface of the V-shaped groove 11 and the second metallic film 25 having raised and recessed portions formed on the outer circumference of the optical fiber 20 are bonded together by surface activated bonding, and the optical fiber 20 is thus bonded fixedly to the silicon substrate 10.

The two groove faces 11a and 11b of the V-shaped groove 11 of the silicon substrate 10 are flat faces, while the outer circumference of the optical fiber 20 is circular. Accordingly, two contacting portions 17a and 17b (in the figure, indicated by thick broken lines as if seen through the optical fiber 20), where the first metallic film 12 formed on the V-shaped groove 11 of the silicon substrate 10 contacts the second metallic film 25 formed on the outer circumference of the optical fiber 20, are formed at prescribed intervals in a discontinuous manner along the longitudinal direction of the respective groove faces 11a and 11b.

The second metallic film 25 on the outer circumference of the optical fiber 20 is provided with the stripe-shaped raised and recessed portions formed in a periodically repeating fashion, as earlier described. Therefore, the first metallic film 12 actually contacts the second metallic film 25 of the optical fiber 20 only at the raised portions 25a thereof and does not contact at the recessed portions 25b. Accordingly, the two contacting portions 17a and 17b are each located in a discontinuous manner in the regions of the raised portions 25a formed in a periodically repeating fashion,

As shown in FIG. 13(b), as in the optical device 1, the optical fiber 20 is fixedly bonded along the longitudinal direction thereof with a portion of the optical fiber 20 embedded in the V-shaped groove 11 of the silicon substrate 10. The contacting portion 17b (in the figure, the contacting portion 17a is not shown) is formed at prescribed intervals in a discontinuous manner along the longitudinal direction of the optical fiber 20 and the V-shaped groove 11. The structure formed by fixedly bonding the silicon substrate 10 and the optical fiber 20 in integral fashion as shown in FIG. 13 is the optical device 3 manufactured by the manufacturing method to be described later.

As described above, in the optical device 3, the contact between the silicon substrate 10 and the optical fiber 20 is close to a multiple-point contact, as in the case of the optical device 2. As a result, since the load applied for bonding is further concentrated at the contacting portions 17a and 17b that are close to point contacts, the silicon substrate 10 and the optical fiber 20 can be bonded together by surface activated bonding under a load smaller than that required in the case of the optical fiber 1. Further, in the optical device 3, if approximately the same load as that used in the bonding step of the optical device 1 is applied for bonding, the bonding strength can be further increased, since the large load is concentrated at the contacting portions 17a and 17b.

The pattern of the raised and recessed portions of the second metallic film 25 of the optical fiber 20 need not be limited to the stripe-shaped pattern. The pattern of the raised and recessed portions of the second metallic film 25 of the optical fiber 20 may be formed in any suitable pattern, the only requirement is that they be formed in a periodically repeating fashion along the portions where the second metallic film 25 contacts the first metallic film 12 of the silicon substrate 10.

The fabrication process of the optical device 3 is the same as the fabrication process of the optical device 1 described earlier (see FIG. 4), except the step for forming the raised and recessed portions in the second metallic film 25 on the outer circumference of the optical fiber 20 and the bonding step for bonding the optical fiber 20 to the silicon substrate 10; therefore, the other steps will not be further described herein. The step for forming the raised and recessed portions in the second metallic film 25 on the outer circumference of the optical fiber 20 is added in the second metallic film forming step S6 shown in FIG. 4, but the details of the step are essentially the same as those of the raised/recessed portion forming step of the optical device 2 described earlier (laser processing step (see FIG. 7) or etching step (see FIG. 8)).

One feature of the manufacturing method of the optical device 3 is that the flat-patterned first metallic film formed on the V-shaped groove of the substrate and the second metallic film formed on the outer circumference of the optical fiber, with the stripe-shaped raised and recessed portions formed in a periodically repeating fashion, are bonded together by surface activated bonding.

The bonding step S7 for bonding the optical fiber 20 to the silicon substrate 10 (including the height adjustment of the optical fiber) in the optical device 3 is essentially the same as the bonding step of the optical device 2 (see FIGS. 9 to 11), the only difference being where the raised and recessed portions are formed (the silicon substrate 10 or the optical fiber 20), and therefore, the description will not be repeated here. Further, the effect achieved by forming the raised and recessed portions in the second metallic film 25 on the outer circumference of the optical fiber 20 is the same as that achieved by forming the raised and recessed portions in the surface of the first metallic film 13 of the optical device 2.

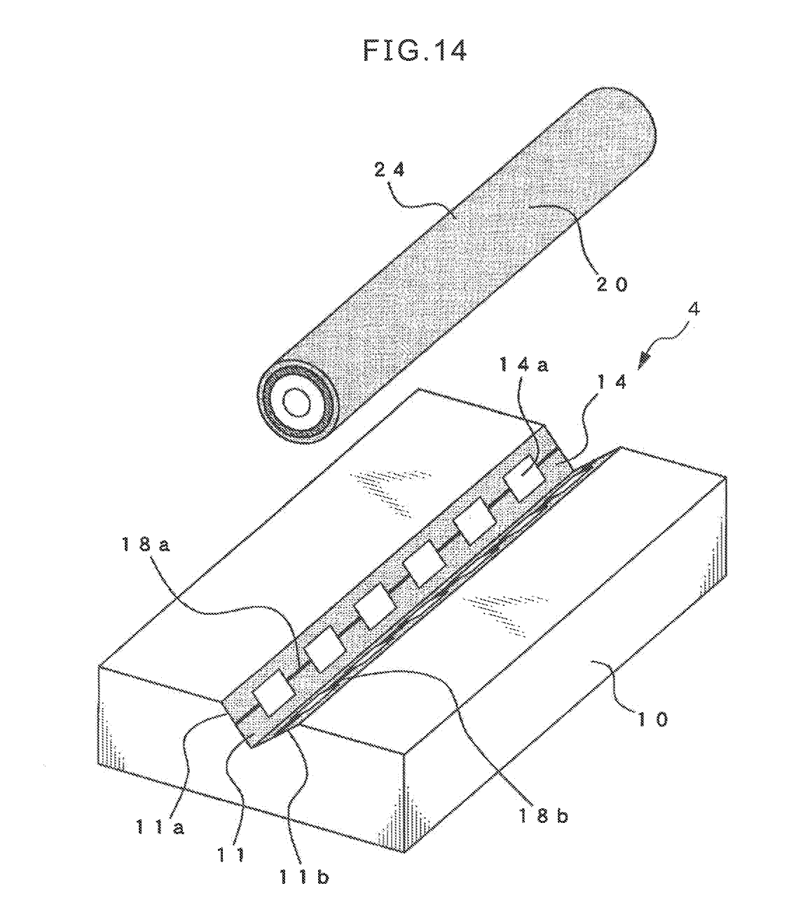

FIG. 14 is a perspective view schematically showing the structure of a further alternative optical device 4 before the substrate and the optical fiber are bonded together. In FIG. 14, the same component elements as those in FIG. 1 are designated by the same reference numerals, and the description of such component elements will not be repeated here.

In FIG. 14, the V-shaped groove 11 of a prescribed size is formed in the surface of the silicon substrate 10, and a first metallic film 14 having a plurality of rectangular openings 14a formed in a periodically repeating fashion along the longitudinal direction of the V-shaped groove 11 is formed on the surface of the V-shaped groove 11. The material of the first metallic film 14 is Au.

The openings 14a in the first metallic film 14 are each formed by removing the metallic film and exposing the surface of the V-shaped groove 11 of the silicon substrate 10, but need not necessarily be limited to this specific structure; for example, the openings 14a may each be covered with a metallic film thinner than the first metallic film 14 forming the entire region other than the openings.

As in the optical device 1, the outer circumference of the optical fiber 20 is covered with the flat-patterned second metallic film 24. The material of the second metallic film 24 is Au.

The optical fiber 20 is fitted into the V-shaped groove 11 of the silicon substrate 10 and pressed thereon under a prescribed load. Thereupon, the first metallic film 14 formed on the surface of the V-shaped groove 11 and the second metallic film 24 formed on the outer circumference of the optical fiber 20 are bonded together by surface activated bonding, and the optical fiber 20 is thus bonded fixedly to the silicon substrate 10.

Contacting portions 18a and 18b (indicated by thick lines) where the optical fiber 20 contacts the silicon substrate 10 are formed at prescribed intervals in a discontinuous manner along the longitudinal direction of the respective groove faces 11a and 11b of the V-shaped groove 11, as in the case of the optical device 2. As described above, the first metallic film 14 is provided with the rectangular openings 14a formed in a periodically repeating fashion along the longitudinal direction of the V-shaped groove 11. Therefore, the second metallic film 24 of the optical fiber 20 actually contacts the first metallic film 14 only at regions other than the regions of the openings 14a. Accordingly, the two contacting portions 18a and 18b are each located in a discontinuous manner in the regions other than the regions of the openings 14a.

As described above, in the optical device 4, the rectangular openings 14a are formed on the surface of the V-shaped groove 11 of the silicon substrate in a periodically repeating fashion along the longitudinal direction of the V-shaped groove 11. Further, the two contacting portions 18a and 18b where the optical fiber 20 in the optical device 4 contacts the V-shaped groove 11 are similar to the two contacting portions 16a and 16b formed in the optical device 2. As a result, when the load is applied to the optical fiber 20 in the bonding step, the load concentrates at the contacting portions 18a and 18b formed in the regions other than the regions of the openings 14a; therefore, the optical fiber 20 can be fixedly bonded even when the applied load is relatively small.

When the metallic film in the contact area is compressed under the load concentrated at the contacting portions 18a and 18b, the metallic film is allowed to spread into its adjacent openings 14a. Accordingly, in common with the optical device 2, the optical device 4 offers the excellent advantage that the adjustment range of the height of the optical axis of the optical fiber 20 relative to the silicon substrate 10 can be enlarged by increasing the amount by which the area other than the openings 14a can be compressed. The shape of each opening 14a need not be limited to a rectangle, but may be formed, for example, in a circular shape.

In the optical device 4, the openings 14a can be formed by laser processing or by etching in the same manner as the process step for forming the raised and recessed portions in the optical device 2 (see FIGS. 7 and 8), and therefore, the details of the process step will not be described herein. Further, in the optical device 4, the bonding step for bonding the optical fiber 20 to the silicon substrate 10 and the step for adjusting the height of the optical fiber 20 are the same as the corresponding steps in the optical 2 (see FIGS. 9 to 11), and therefore, the details of these process steps will not be described herein.

In the optical device 4, the first metallic film 14 having the openings 14a is formed on the V-shaped groove 11 of the silicon substrate 10, and the flat-patterned second metallic film 24 is formed around the outer circumference of the optical fiber 20, but the optical device 4 is not limited to this specific structure; for example, the flat-patterned first metallic film may be formed on the V-shaped groove 11 of the silicon substrate 10, and the second metallic film provided with openings may be formed around the outer circumference of the optical fiber 20.

One feature of the manufacturing method of the optical device 4 is that the first metallic film formed on the V-shaped groove of the substrate, with the openings formed in a periodically repeating fashion, and the flat-patterned second metallic film formed on the outer circumference of the optical fiber are bonded together by surface activated bonding.

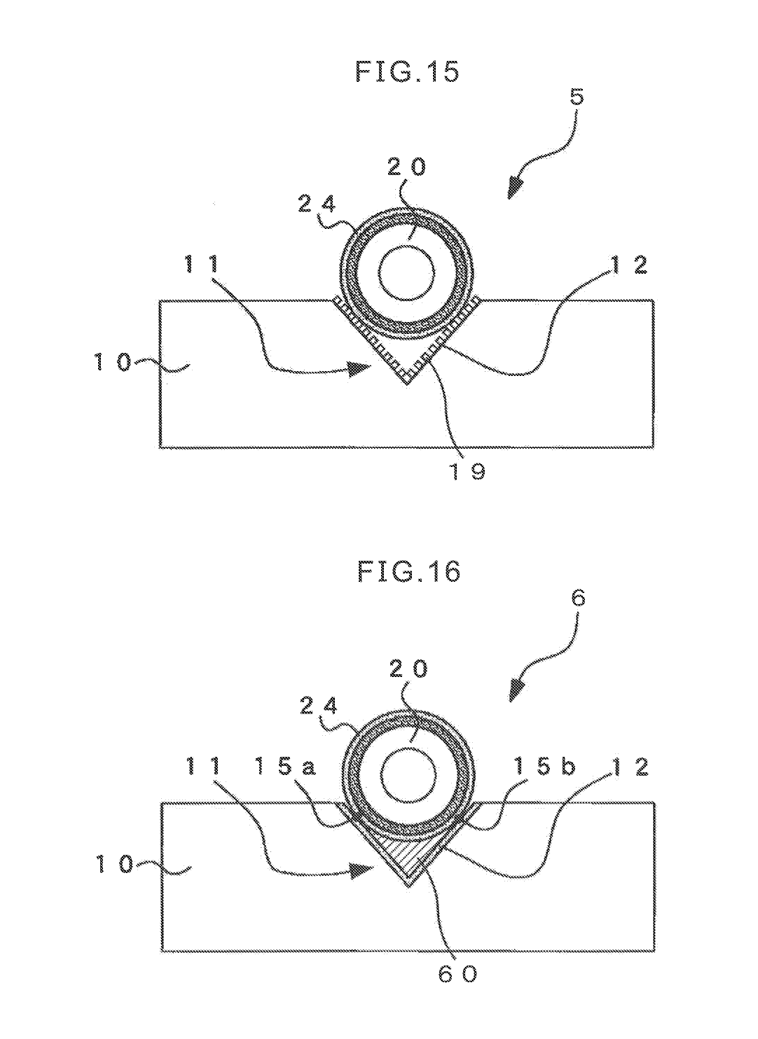

FIG. 15 is a diagram showing a further alternative optical device 5. In FIG. 15, the same component elements as those in FIG. 1 are designated by the same reference numerals, and the description of such component elements will not he repeated.

In FIG. 15, the V-shaped groove 11 of a prescribed size is formed in the surface of the silicon substrate 10, and a metallic film provided with micro-bumps 19 is formed on the surface of the V-shaped groove 11. The material of the micro-bumps is Au. The micro-bumps 19 will be described in detail later.

As in the optical device 1, the outer circumference of the optical fiber 20 is covered with the flat-patterned second metallic film 24. The material of the second metallic film 24 is Au.

The optical fiber 20 is fitted into the V-shaped groove 11 of the silicon substrate 10 and pressed thereon under a prescribed load. Thereupon, the micro-bumps 19 formed on the surface of the V-shaped groove 11 and the second metallic film 24 formed on the outer circumference of the optical fiber 20 are bonded together by surface activated bonding, and the optical fiber 20 is thus bonded fixedly to the silicon substrate 10.

The micro-bumps 19 are formed by dry-etching or wet-etching an Au film formed by sputtering on the surface of the V-shaped groove 11. The micro-bumps 19 are cylindrically shaped protrusions, each with a height of 2 μm and a diameter of 5 μm, and are arranged with uniform spacing at a pitch of 10 to 25 μm in the lateral and longitudinal directions. The shape, height, width, pitch, etc., of the micro-bumps are only examples, and are not limited to those described above. Since the micro-bumps 19 are formed by etching the Au flim formed by sputtering, the heights of the micro-bumps 19 are precisely egual across the entire area.

The only difference between the manufacturing method of the optical device 5 shown in FIG. 15 and the manufacturing method of the optical device 1 earlier described is that, in the optical device 5, the micro-bumps 19 are formed by etching after forming the first metallic film 12 on the surface of the V-shaped groove 11 (see S4 in FIG. 4). Compared with the flat-patterned first metallic film 12, the micro-bumps 19 are easier to compress under pressure, and hence the control is easy when positioning the optical fiber 20.

FIG. 16 is a diagram showing a further alternative optical device 6. In FIG. 16, the same component elements as those in FIG. 1 are designated by the same reference numerals, and the description of such component elements will not be repeated.

The difference between the optical device 6 shown in FIG. 16 and the optical device 1 shown in FIG. 1 is that, in the optical device 6, the gap created between the V-shaped groove 11 and the optical fiber 20 is filled with a bonding resin 60.

In FIG. 16, the V-shaped groove 11 of a prescribed size is formed in the surface of the silicon substrate 10, and the first metallic film 12 is formed on the surface of the V-shaped groove 11. The material of the first metallic film 12 is Au. As in the optical device 1, the outer circumference of the optical fiber 20 is covered with the flat-patterned second metallic film 24. The material of the second metallic film 24 is Au.

The optical fiber 20 is fitted into the V-shaped groove 11 of the silicon substrate 10 and pressed thereon under a prescribed load. Thereupon, the first metallic film 12 formed on the surface of the V-shaped groove 11 and the second metallic film 24 formed on the outer circumference of the optical fiber 20 are bonded together by surface activated bonding, and the optical fiber 20 is thus bonded fixedly to the silicon substrate 10.

The only difference between the manufacturing method of the optical device 6 shown in FIG. 16 and the manufacturing method of the optical device 1 earlier described is that, in the optical device 6, the step for filling the bonding resin 60 into the gap created between the V-shaped groove 11 and the optical fiber 20 is added after fixedly bonding the optical fiber 20 to the silicon substrate 10. Since the optical fiber 20 is bonded to the silicon substrate 10 by surface activated bonding, the position of the optical fiber 20 relative to the optical fiber 10 is unaffected even when the bonding resin 60 is caused to contract or expand under the effect of heat, etc. Furthermore, in the optical device 6, the optical fiber 20 can be fixedly bonded to the silicon substrate 10 in a more secure manner by the bonding resin 60. In the fabrication of the optical device 6, the optical fiber 20 may be fixedly bonded to the silicon substrate 10 in accordance with any one of the manufacturing methods described in connection with the optical devices 2 to 7.

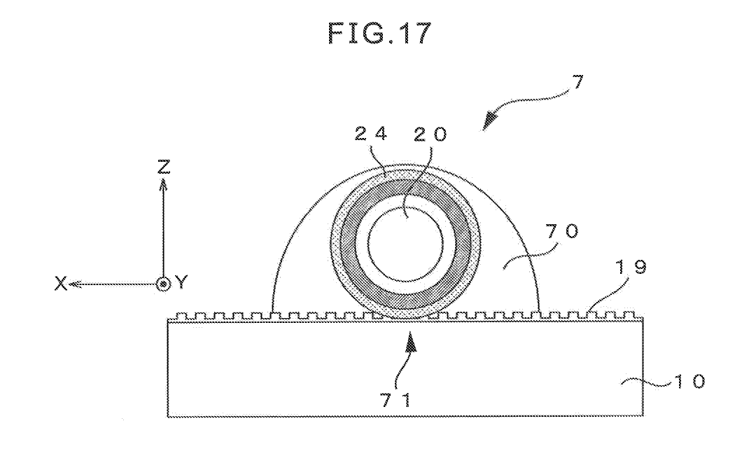

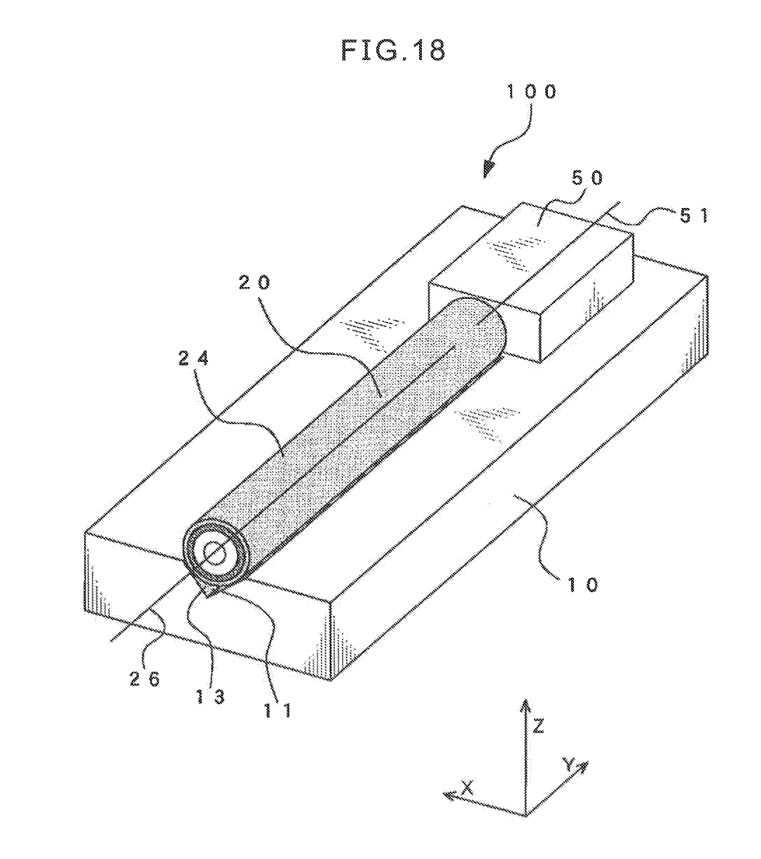

FIG. 17 is a diagram showing a further alternative optical device 7. In FIG. 17, the same component elements as those in FIG. 1 are designated by the same reference numerals, and the description of such component elements will not be repeated here.

The difference between the optical device 6 shown in FIG. 17 and the optical device 5 shown in FIG. 15 is that the optical device 7 does not include the V-shaped groove 11 but instead includes a reinforcing resin 70.

In FIG. 17, micro-bumps 19 are formed as a datum plane surface on the surface of the silicon substrate 10. The material of the micro-bumps 19 is Au. The geometry and the method of fabrication of the micro-bumps 19 are the same as those described for the optical device 5.

As in the optical device 1, the outer circumference of the optical fiber 20 is covered with the flat-patterned second metallic film 24. The material of the second metallic film 24 is Au.

The optical fiber 20 is placed in a designated position on the silicon substrate 10, and pressed thereon under a prescribed load. Thereupon, the micro-bumps 19 formed on the silicon substrate 10 and the second metallic film 24 formed on the outer circumference of the optical fiber 20 are bonded together by surface activated bonding, and the optical fiber 20 is thus bonded fixedly to the silicon substrate 10.

The manufacturing method of the optical device 7 shown in FIG. 17 differs from the manufacturing method of the optical device 5 earlier described, in that the V-shaped groove 11 is not formed but instead the micro-bumps 19 are formed on the datum plane surface of the substrate 10, and in that the manufacturing method includes a step for fixing (or reinforcing) the optical fiber 20 with the reinforcing resin 70 after fixedly bonding the optical fiber 20 to the silicon substrate 10.

Compared with the flat-patterned first metallic film 12 of the optical device 1, the micro-bumps 19 are easier to compress under pressure, and hence the control (adjustment) in the height direction (Z-axis direction in the figure) relative to the silicon substrate 10 is easy when positioning the optical fiber 20, as in the case of the optical device 5.

Since the optical device 7 shown in FIG. 17 does not include the V-shaped groove 11, the position of the optical fiber 20 on the silicon substrate 10 can also be adjusted in the lateral direction (X-axis direction in the figure) by moving the optical fiber 20. This adjustment can be made because there is space in the lateral direction of the optical fiber 20. Furthermore, since the heights of all the micro-bumps 19 can be aligned precisely by reference to the datum plane surface of the substrate 10, the adjustment in the height direction can be made more precisely than in the case of the V-shaped groove.

In the optical device 7 shown in FIG. 17, the micro-bumps 19 are formed on the datum plane surface of the substrate 10, but instead of the micro-bumps 19, the first metallic film 13 having the stripe-shaped raised and recessed portions, such as shown in the optical device 2, or the first metallic film 14 having the openings 14a, such as shown in the optical device 4, may be formed on the datum plane surface of the substrate 10. Even when the first metallic film 13 having the stripe-shaped raised and recessed portions or the first metallic film 14 having the openings 14a is formed on the datum plane surface, there is space in the lateral direction of the optical fiber 20. It is therefore possible to control (adjust) the position of the optical fiber 20 on the silicon substrate 10 in the lateral direction (X-axis direction in the figure).

FIG. 18 is a perspective view showing a further alternative optical device 100.

The optical device 100 is manufactured by fixedly bonding the optical fiber 20 to the silicon substrate 10 in accordance with the manufacturing method described for the optical device 2. Alternatively, the optical device 100 may be manufactured by fixedly bonding the optical fiber 20 to the silicon substrate 10 in accordance with any one of the manufacturing methods described for the optical devices 1 and 3 to 7.

In the optical device 100, the same component elements as those in the optical device 2 are designated by the same reference numerals, and the description of such component elements will not be repeated. The optical device 100 includes a semiconductor laser 50 in addition to the silicon substrate 10 and the optical fiber 20 fixedly bonded to the silicon substrate 10.

The semiconductor laser 50 is fixedly bonded to the silicon substrate 10 via micro-buxos or the like (not shown). The first metallic film 13 formed on the V-shaped groove 11 and the second metallic film 24 formed on the outer circumference of the optical fiber 20 are bonded together by surface activated bonding, and the la optical fiber 20 is thus bonded fixedly to the silicon substrate 10.

It is extremely important to fixedly bond the optical fiber 20 by aligning the optical axis 26 of the optical fiber 20 with the optical axis 51 of the laser light that the semiconductor laser 50 outputs. The optical fiber 20 is fitted into the V-shaped groove 11, and its position in both horizontal directions (X-axis and Y-axis directions) relative to the silicon substrate 10 is fixed. On the other hand, the height (in the Z-axis direction) of the optical fiber 20 can be adjusted by varying the bonding load and thereby adjusting the amount of compression of the raised portions 13a of the first metallic film 13 (see FIG. 10).

Accordingly, in the optical device 100, a precise optical axis alignment between the optical elements (semiconductor laser 50 and optical device 20) mounted on the silicon substrate 10 can be accomplished by adjusting the load. It is thus possible to manufacture a high-performance optical device that achieves optimum optical coupling.

Though not shown in FIG. 18, metallic films, interconnection patterns, etc., for bonding other optical elements can also be formed efficiently on the surface of the silicon substrate 10 simultaneously with the formation of the first metallic film 13 on the surface of the V-shaped groove 11 of the silicon substrate 10. It is thus possible to easily achieve an optical device in which a plurality of optical elements are integrated efficiently on a silicon substrate.

The optical device and the optical device manufacturing method described above can be widely applied in a variety of fields such as laser projectors, laser light illumination equipment, optical tweezers, and the like.

1-15. (canceled)

16. A method for manufacturing an optical device with an optical fiber mounted on a substrate, comprising the steps of:
forming micro-bumps on a portion of said substrate;
forming a metallic film on a portion of an outer circumference of said optical fiber;
bonding together with micro-bumps and said metallic film by surface activated bonding at normal temperature without heating for bonding; and
adjusting the position of an optical axis of said optical fiber by compressing said micro-bumps.

17. The optical device manufacturing method according to claim 16, further comprising the step of forming a V-shaped groove in said surface, and
wherein said microbumps are formed on said V-shaped groove.

18. The optical device manufacturing method according to claim 16, further comprising the step of fixing said optical fiber onto said first metallic film by using a reinforcing resin.

19. The optical device manufacturing method according to claim 16, wherein said micro-bumps are formed of Au.

20. The optical device manufacturing method according to claim 16, further comprising the steps of:
bonding a light emitting device on said substrate; and
adjusting the position between said optical axis of said optical fiber and an optical axis of an emitted light from said light emitting device by compressing said micro-bumps.

21. The optical device manufacturing method according to claim 16, wherein second micro-bumps formed on said substrate and said light emitting device are bonded together by surface activated bonding at normal temperature without heating for bonding.
